(19) United States
(12) Patent Application Publication
(10) Pub. No.: US 2023/0180729 A1
(43) Pub. Date: Jun. 15, 2023

(54) PLIABLE FISHING LURE

(71) Applicant: The Kerry Project, LLC, Santa Ana, CA (US)

(72) Inventor: Kenneth P. Kerry, Santa Ana, CA (US)

(21) Appl. No.: 18/065,274

(22) Filed: Dec. 13, 2022

Related U.S. Application Data
(60) Provisional application No. 63/288,754, filed on Dec. 13, 2021.

(51) Int. Cl. A01K 85/00

(52) U.S. Cl. CPC A01K 85/1867; A01K 85/1811

(57) ABSTRACT

A fishing lure includes a pliable body having a forward portion configured to produce drag on the pliable body when moved through water in a prescribed direction. The pliable body additionally includes an upper edge having a forward segment extending from the forward portion, a rearward segment extending away from the forward segment, and a middle segment located between the forward and rearward segments and forming an apex between the forward and rearward segments. A pair of eyes are included on opposed sides of the pliable body. The fishing lure further includes a hook connector having a corkscrew portion and an axial portion. The hook connector is connected to the pliable body such that the corkscrew portion is located within the pliable body and a segment of the axial portion extends out of the planar forward surface of the pliable body to facilitate attachment to a hook.

### CROSS-REFERENCE TO RELATED APPLICATIONS

The present application claims the benefit of U.S. Provisional Application Ser. No. 63/288,754, filed Dec. 13, 2021, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to a fishing lure, and more specifically to a fishing lure specifically configured and adapted to accurately mimic real life motion of bait-type fish, as well as to mitigate inadvertent tearing of a hook connector from a lure body.

### 2. Description of the Related Art

Baited fishhooks (e.g., lures) have been widely used as a means of catching fish in both freshwater and saltwater. Although there are a wide variety of fishhooks, there are some features that are common in most fishhooks, such as an eye to facilitate attachment to a fishing line, and a pointed or barbed end opposite the eye. The bait may include worms and small fish, as well as frogs, shrimp, and a variety of insects. The bait may be real (e.g., real worms, fish, etc.) or fake/artificial (e.g., fake worms, fish, etc.). During use, the bait may be attached to the fishhook such that when the fish bites at the bait, the fish may become caught on the fishhook.

Attempts have been made to make artificial bait appear more life-like and perform more natural movements. In this regard, spinners, lips, and flaps have been added to artificial bait to achieve more realistic movement. The incorporation of such supplemental features to artificial bait has, in many instances, produced a mechanical or repetitive swimming action as it is pulled through the water, which is not consistent with random action or motion typically associated with real fish or bait. As such, the unnatural motion of conventional artificial bait may not yield the desired results when fishing.

Another drawback typically associated with conventional artificial bait is that the artificial structure may easily tear or break during use. In this regard, the artificial bait may include a hook connector, a portion of which is embedded therein to facilitate attachment to a hook. If the hook connector and artificial bait are pulled in opposite directions with enough force, the hook connector may be pulled out of the artificial bait. This may happen if the lure becomes snagged on weeds or if the fish bites at a rear end portion of the lure.

Accordingly, there is a need in the art for a stronger, more lifelike fishing lure. Various aspects of the present disclosure address this particular need, as will be discussed in more detail below.

### BRIEF SUMMARY

In accordance with one embodiment of the present disclosure, a fishing lure includes a pliable body having a head portion including a planar forward surface. The pliable body additionally includes an upper edge having a forward segment extending from the head portion, a rearward segment extending away from the forward segment, and a middle segment located between the forward and rearward segments and forming an apex between the forward and rearward segments. A pair of eyes are located on opposed sides of the pliable body. The fishing lure further includes a hook connector having a corkscrew portion and an axial portion. The hook connector is connected to the pliable body such that the corkscrew portion is located within the pliable body and a segment of the axial portion extends out of the planar forward surface of the pliable body to facilitate attachment to a hook.

The planar forward surface may define a surface area of between 10-60 mm².

Each of the pair of eyes may include a respective planar surface.

The hook connector may additionally include an eyelet, and the axial portion may extend between the eyelet and the corkscrew portion. The hook connector may define a length as a distance between the eyelet and a terminal end of the corkscrew portion, with the length being between 1.5 cm and 2.5 cm. A length of the axial portion may be approximately 6 mm or 13 mm, or any length therebetween.

According to another embodiment, there is provided a fishing lure including a pliable body extending along a longitudinal axis. The pliable body includes a forward portion configured to produce drag on the pliable body when the pliable body is moved through water in a prescribed direction. The pliable body additionally includes an upper edge having a forward segment extending from the forward portion, a rearward segment extending away from the forward segment, and a middle segment located between the forward and rearward segments and forming an apex between the forward and rearward segments. A pair of eyes are included on opposed sides of the pliable body. The fishing lure further includes a hook connector having a corkscrew portion and an axial portion. The hook connector is connected to the pliable body such that the corkscrew portion is located within the pliable body and a segment of the axial portion extends out of the planar forward surface of the pliable body to facilitate attachment to a hook.

The planar, drag-inducing, forward surface may be generally perpendicular to the longitudinal axis. The planar, drag-inducing forward surface may define a surface area of between 10-60 mm².

According to yet another embodiment, there is provided a fishing lure comprising a pliable body having a head portion including a planar forward surface. The pliable body additionally includes an upper edge having a forward segment extending from the head portion, a rearward segment extending away from the forward segment, and a middle segment located between the forward and rearward segments and forming an apex between the forward and rearward segments. A pair of eyes are located on opposed sides of the pliable body.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a top view of a fishing lure body constructed in accordance with an embodiment of the present disclosure;

FIG. 2 is a side view of the fishing lure body of FIG. 1;

FIG. 3 is a bottom view of the fishing lure body of FIG. 1;

FIG. 4 is a side view of the fishing lure body of FIG. 1 with a hook connector coupled thereto; and

FIG. 5 is a top view of the fishing lure body and hook connector of FIG. 4.

Common reference numerals are used throughout the drawings and the detailed description to indicate the same elements.

### DETAILED DESCRIPTION

The detailed description set forth below in connection with the appended drawings is intended as a description of certain embodiments of a fishing lure and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure relate to a fishing lure specifically configured and adapted to mimic the action of real fish used as bait, such as minnows. The fishing lure maybe shaped like a real-life minnow, and include a forward, drag-inducing surface, which imparts drag or resistance on the fishing lure as it is pulled through the water. The drag may cause side-to-side action of the fishing lure, which may simulate swimming movement of a real fish, thereby making the fishing lure more attractive to targeted fish. The fishing lure may also be specifically configured and adapted to enhance strength between a fishing lure body and a hook connector. In this respect, the hook connector may include a corkscrew portion that may be inserted or embedded deeper into the fishing lure body than conventional hook connectors. The deeper connection may be facilitated by an elongate, axial segment of the hook connector that extends from the corkscrew portion and through an outer surface of the lure body. The drag-inducing surface may be generally planar, which may provide an easier surface for insertion of the corkscrew portion than conventional, rounded forward edges or surfaces. Furthermore, the fishing lure may include a pair of eyes, the configuration of which may facilitate attachment of the eyes to the fishing lure body such that the eyes may not extend into the body of the fishing lure so as to allow for more material around the corkscrew portion to strengthen the attachment therebetween.

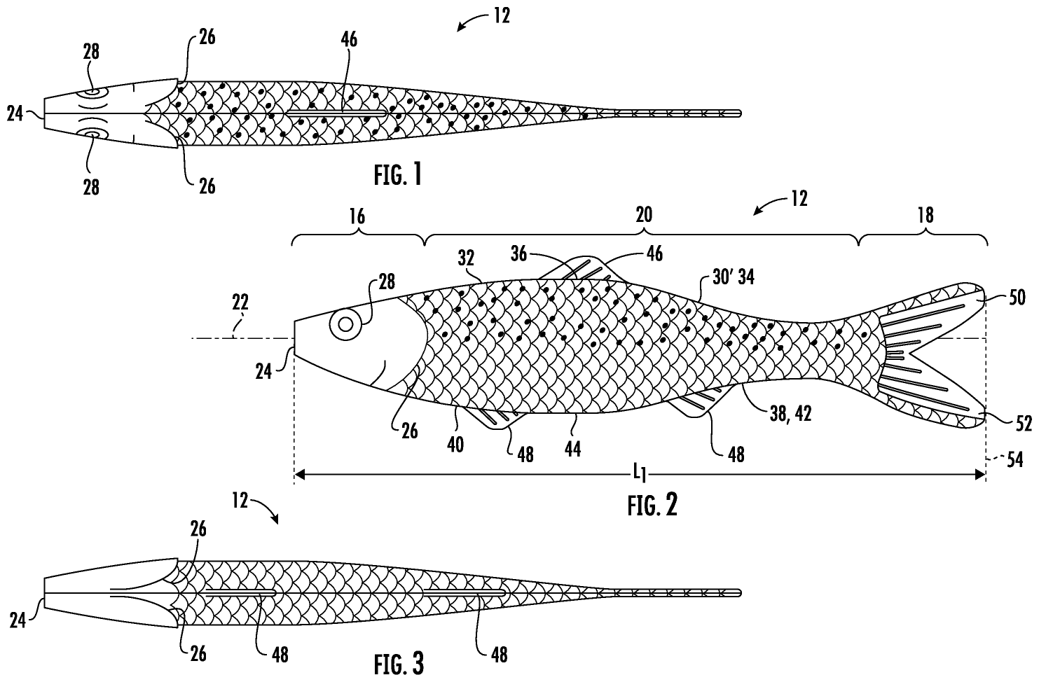

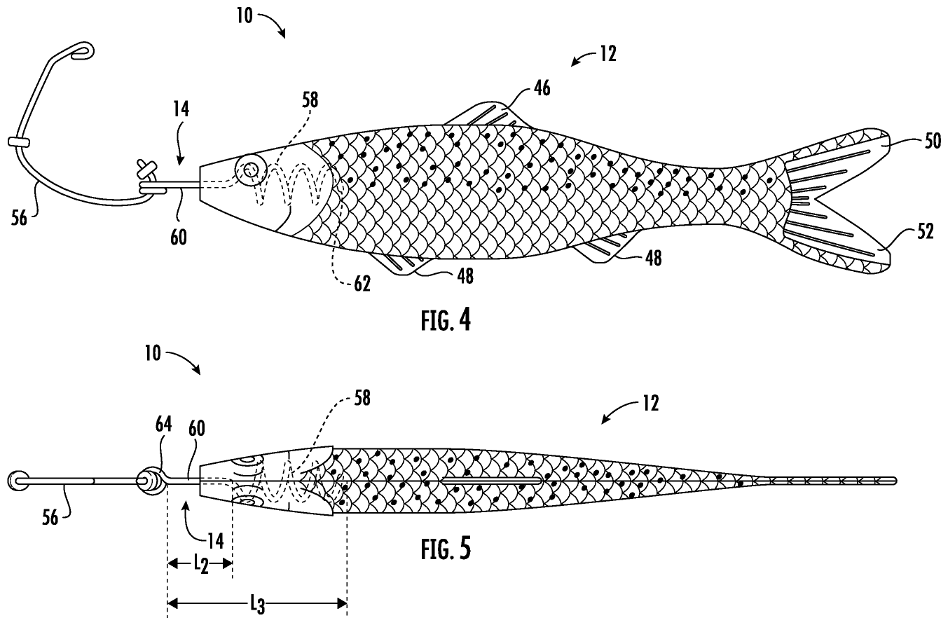

Referring now to the drawings, wherein the showings are for purposes of illustrating preferred embodiments of the present disclosure and are not for purposes of limiting the same, there is depicted a fishing lure 10 generally comprised of a pliable body 12 and a hook connector 14 attachable to the pliable body 12. FIGS. 1-3 show the pliable body 12 without the hook connector 14, while FIGS. 4-5 show the fishing lure 10, with the hook connector 14 attached to the pliable body 12.

The pliable body 12 generally includes a head portion 16, a tail portion 18, and an intermediate portion 20 between the head portion 16 and the tail portion 18. The pliable body 12 extends along a longitudinal axis 22 between the head portion 16 and the tail portion 18. The head portion 16 (e.g., a forward portion) may include a forward segment, a rear segment, an upper edge and a lower edge, with the upper and lower edges extending between the forward and rear segments. The forward segment terminates at an exposed, planar forward surface 24 configured to produce drag on the pliable body 12 when the pliable body 12 is moved through water in a prescribed direction. In this regard, the planar forward surface 24 may be generally perpendicular to the longitudinal axis 22 to impede the flow of water around the lure 10 as the lure 10 moves through the water in a direction that is generally parallel to the longitudinal axis 22. The drag induced by the planar forward surface 24 may create turbulence in the water and cause the lure 10 to move in a non-linear, generally random, path as it is pulled by the fishing line. In this regard, the drag may urge or push the lure 10 in a direction away from the longitudinal axis 22. Subsequently, the tension in the fishing line may pull the lure 10 back toward its previous orientation. These two forces, namely, the drag inhibiting forward motion of the lure 10 and the tension in the fishing line encouraging forward motion of the lure 10, may result in the lure 10 mimicking the conventional movement associated with fish locomotion, which commonly includes wave-like lateral flexions of the fish's body and tail in the water. The ability to mimic movements commonly associated with real fish may make the lure 10 more attractive to target fish.

According to one embodiment, the planar forward surface 24 may define a surface area of between 10-60 mm², although other sizes may be adopted without departing from the spirit and scope of the present disclosure. Furthermore, the planar forward surface 24 may be configured in many different shapes, including but not limited to, quadrangular, circular, oval, trapezoidal, etc.

Although a preferred embodiment may include a planar forward surface 24 that is generally perpendicular to the longitudinal axis 22, it is contemplated the orientation of the planar forward surface 24 is not limited thereto. For instance, the planar forward surface 24 may be offset slightly from being perpendicular (e.g., slightly angled upwardly, downwardly, or to either side) without departing from the spirit and scope of the present disclosure. Furthermore, it is contemplated that other embodiments of the lure 10 may include a non-planar, forward, drag inducing surface, such as a concave surface.

The rear segment of the head portion 16 may include a pair of opposed curved edges 26 that extends outward relative to the adjacent intermediate portion 20 and simulates a pair of gills. Each curved edge 26 may be convex in shape and extend toward the intermediate portion 20. In this regard, each gill may define a physical ridge that protrudes outwardly relative to the adjacent intermediate portion 20.

The head portion 16 may further be configured to be connected to a pair of eyes 28. In one particular embodiment, the head portion 16 may include a pair of shallow recesses that may accommodate the pair of eyes 28, with each eye 28 being partially received within a shallow recess. The eyes 28 themselves may be holographic eyes and include a generally flat surface and may be of a low-profile to facilitate attachment to the lure body 12 without extending too far into the lure body 12. In this regard, it may be desirable to allow for more lure body material in the head portion 16 (rather than being removed or replaced to accommodate the eyes 28) to allow for a stronger attachment with the hook connector 14, as will be described in more detail below. In certain embodiments, the head portion 16 may be formed without recesses for the eyes 28, in which case, the eyes 28 would be attached to an outer surface of the head portion 16.

The head portion 16 may be tapered, such that a distance between the upper edge and the lower edge decreases from the gills (e.g., curved edges 26) to the planar forward surface 24. The tapered profile may mimic the shape of real minnows, thereby enhancing the attractiveness of the lure 12 in the minds of potential target fish.

The intermediate portion 20 may include an upper edge 30 having a forward segment 32 extending from the head portion 16, a rearward segment 34 extending away from the forward segment 32, and a middle segment 36 located between the forward and rearward segments 32, 34 and forming an apex between the forward and rearward segments 32, 34. The intermediate portion 20 may also include a lower edge 38 having a forward segment 40 extending from the head portion 16, a rearward segment 42 extending toward the tail portion 18 and a middle segment 44 located between the forward and rearward segments 40, 42. The forward segment 40 may extend downwardly from the head portion 16, and the rearward segment 42 may extend upwardly from the middle segment 44. Thus, the thickness of the intermediate portion 20 (e.g., a distance between the upper edge 30 and the lower edge 38) may be greatest at the middle segments 36, 44 and may taper toward both of the head portion 16 and the tail portion 18.

The intermediate portion 20 may additionally include one or more fins, which may achieve aesthetic, as well as functional, objectives. As to aesthetics, the fin(s) may mimic similar structures on real fish, that may be identified by target fish. As to function, the fin(s) may provide a degree of stability to the lure 10 as the lure 10 moves within the water. In the exemplary embodiment, the lure 10 includes a single upper fin 46, and a pair of lower fins 48. The upper fin 46 may extend from the upper edge 30 at the middle segment/apex 36, with the forward segment 32 and rearward segments 34 extending from the upper fin 46 in opposite directions. As to the lower fins 48, one of the lower fins 48 may extend from the forward segment 40 of the lower edge 38, while the other lower fin 48 may extend from the rearward segment 42 of the lower edge 38.

The tail portion 18 extends from the intermediate portion 20 and may be forked or generally divided to define an upper tail fin 50 and a lower tail fin 52. Each of the upper and lower tail fins 50, 52 may terminate at a distal-most point or edge. In one embodiment, the upper and lower tail fins 50, 52 may be similar in size, and thus, the distal-most portions of the upper and lower tail fins may reside on a common distal-most axis 54. However, in other embodiments, one of the upper and lower tail fins 50, 52 may be longer than the other, and thus, the longer one of the fins 50, 52 may reside on the distal-most axis 54, while the shorter one of the fins 50, 52 may be spaced from the distal-most axis 54. In this regard, the particular configuration and shape of the fins 50, 52 may vary without departing from the spirit and scope of the present disclosure.

The lure body 12 may define a length L₁ as the maximum distance along the longitudinal axis 22 between the head portion 16 and the tail portion 18, and in particular, between the forward planar surface 24 and the distal-most axis 54 defined by the tail portion 18. The length L may vary between 50-200 mm, and more specifically between 70-140 mm. It is contemplated that the lure body 12 may be sold in small, medium and large sizes, with the small size being 70 mm, the medium size being 120 mm, and the large size being 140 mm.

The lure body 12 may be formed via a molding process from a plastic material, rubber material, or other materials known in the art. The lure body 12 may also include a textured outer surface that mimics scales on a fish. Speckles or other aesthetic elements may be included in the lure body 12 to create a shine or other desired visual effect, such as to reflect light of the lure 10. The material used in the forming the lure body 12 may have a desired color profile, and may be at least partially translucent or transparent, as may be desired.

The lure body 12 is configured to be connected to the hook connector 14, which in turn, is connectable to a hook 56. The hook connector 14 may include a corkscrew portion 58 and an axial portion 60. The corkscrew portion 58 is configured to allow for advancement of the corkscrew portion 58 into the lure body 12 in response to rotation of the corkscrew portion 58 relative to the lure body 12. The planar configuration of the forward drag inducing surface 24 may facilitate insertion of the corkscrew portion 58 into the lure body 12 in a desired direction. In this regard, some prior lure bodies may have a rounded front, rather than a planar front surface, which may be more difficult to work with when trying to insert the corkscrew portion 58.

The corkscrew portion 58 includes a distal tip 62 and a series of helical extensions extending between the distal tip 62 and the axial portion 60. Each helical extension completes 360-degrees. In the exemplary embodiment, the corkscrew portion 58 includes 3.5 helical extensions, which may provide sufficient grip between the lure body 12 and the corkscrew portion 58. It is understood that the corkscrew portion 58 may define more than 3.5 helical extensions (e.g., 5 or more helical extensions) or less than 3.5 helical extensions (e.g., 2 or fewer helical extensions) without departing from the spirit and scope of the present disclosure.

The axial portion 60 extends from the corkscrew portion 58, and in particular, from the proximal-most helical extension and terminates in an eyelet 64, which may be sized to receive the hook 56. A length, L₂ of the axial portion 60, e.g., the distance between the proximal-most helical extension and the eyelet 64 may be approximately 6mm or 13mm, or any length therebetween. The length L₂ of the axial portion may be a significant departure over conventional hook connectors, with the length L₂ allowing the corkscrew portion 58 to be deeply embedded within the lure body 12 to allow for a more secure attachment between the corkscrew portion 58 and the lure body 12. The hook connector 14 may define a length, L₃, as a distance between the eyelet and a terminal end of the corkscrew portion 58, with the length being between 1.5 cm and 2.5 cm.

The hook connector 14 is connected to the pliable body 12 such that the corkscrew portion 58 is located within the pliable body 12 and a segment of the axial portion 60 extends out of the planar forward surface 24 of the pliable body 12 to facilitate attachment to the hook. The diameter of the corkscrew portion 58 is such that the corkscrew portion 58 is smaller than the width of the adjacent portion of the lure body 12. Furthermore, the corkscrew portion 58 may be deeply embedded within the lure body 12 such that a sufficient amount of material of the lure body 12 surrounds the corkscrew portion 58 to secure the corkscrew portion 58 to the lure body 12. Furthermore, when an axial force is applied on the hook connector 14 in a direction in line with the axial portion 60 (e.g., when the axial portion 60 is urged in a direction away from the lure body), the configuration of the corkscrew portion 58 and its placement within the lure body 12 restricts the corkscrew portion 58 from undesirable removal from the lure body 12. Furthermore, the configuration of the corkscrew portion 58 and the lure body 12 which provides for more material around the corkscrew portion 58 relative to conventional lures reduces the likelihood that the corkscrew portion 58 is ripped out of the lure body 12 by biting fish or from casts that inadvertently end up in weeds.

Those skilled in the art will appreciate that any dimension provided herein may be associated with an acceptable tolerance. For instance, an acceptable tolerance may be +/−5% of the stated value, which would include reference to being perpendicular (e.g., 85 degrees to 95 degrees relative to the true perpendicular).

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A fishing lure comprising:
a pliable body having:
a head portion including a planar forward surface; and
an upper edge having a forward segment extending from the head portion, a rearward segment extending away from the forward segment, and a middle segment located between the forward and rearward segments and forming an apex between the forward and rearward segments;
a pair of eyes on opposed sides of the pliable body; and
a hook connector having a corkscrew portion and an axial portion, the hook connector being connected to the pliable body such that the corkscrew portion is located within the pliable body and a segment of the axial portion extends out of the planar forward surface of the pliable body to facilitate attachment to a hook.

2. The fishing lure recited in claim 1, wherein the planar forward surface defines a surface area of between 10-60 mm².

3. The fishing lure recited in claim 1, wherein each of the pair of eyes includes a respective planar surface.

4. The fishing lure recited in claim 1, wherein the hook connector additionally includes an eyelet, the axial portion extending between the eyelet and the corkscrew portion.

5. The fishing lure recited in claim 4, wherein the hook connector defines a length as a distance between the eyelet and a terminal end of the corkscrew portion, the length being between 1.5 cm and 2.5 cm.

6. The fishing lure recited in claim 5, wherein a length of the axial portion is approximately 13 mm.

7. The fishing lure recited in claim 5, wherein a length of the axial portion is approximately 6 mm.

8. The fishing lure recited in claim 1, wherein the pliable body additionally includes a tail portion opposite the head portion, the pliable body extending from the head portion to the tail portion along a longitudinal axis, the planar forward surface being generally perpendicular to the longitudinal axis.

9. A fishing lure comprising:
a pliable body extending along a longitudinal axis, the pliable body having:
a forward portion configured to produce drag on the pliable body when the pliable body is moved through water in a prescribed direction;
an upper edge having a forward segment extending from the forward portion, a rearward segment extending away from the forward segment, and a middle segment located between the forward and rearward segments and forming an apex between the forward and rearward segments;
a pair of eyes on opposed sides of the pliable body; and
a hook connector having a corkscrew portion and an axial portion, the hook connector being connected to the pliable body such that the corkscrew portion is located within the pliable body and a segment of the axial portion extends out of the planar forward surface of the pliable body to facilitate attachment to a hook.

10. The fishing lure recited in claim 9, wherein the planar, drag-inducing, forward surface is generally perpendicular to the longitudinal axis.

11. The fishing lure recited in claim 9, wherein the planar, drag-inducing forward surface defines a surface area of between 10-60 mm².

12. The fishing lure recited in claim 9, wherein each of the pair of eyes includes a respective planar surface.

13. The fishing lure recited in claim 9, wherein the hook connector additionally includes an eyelet, the axial portion extending between the eyelet and the corkscrew portion.

14. The fishing lure recited in claim 13, wherein the hook connector defines a length as a distance between the eyelet and a terminal end of the corkscrew portion, the length being between 1.5 cm and 2.5 cm.

15. The fishing lure recited in claim 14, wherein a length of the axial portion is approximately 13 mm.

16. The fishing lure recited in claim 14, wherein a length of the axial portion is approximately 6 mm.

17. A fishing lure comprising:
a pliable body having:
a head portion including a planar forward surface; and
an upper edge having a forward segment extending from the head portion, a rearward segment extending away from the forward segment, and a middle segment located between the forward and rearward segments and forming an apex between the forward and rearward segments; and
a pair of eyes on opposed sides of the pliable body.

18. The fishing lure recited in claim 17, wherein the planar forward surface defines a surface area of between 10-60 mm².

19. The fishing lure recited in claim 17, wherein each of the pair of eyes includes a respective planar surface.

20. The fishing lure recited in claim 17, wherein the pliable body additionally includes a tail portion opposite the head portion, the pliable body extending from the head portion to the tail portion along a longitudinal axis, the planar forward surface being generally perpendicular to the longitudinal axis.
